(19) United States
(12) Patent Application Publication
(10) Pub. No.: US 2025/0148437 A1
(43) Pub. Date: May 8, 2025

(54) PROVIDING CLOUD COMPUTING SERVICES BASED ON A HOLDING OF CRYPTOCURRENCY

(71) Applicant: Ken Yen Chen Liu, Vancouver (CA)

(72) Inventor: Ken Yen Chen Liu, Vancouver (CA)

(21) Appl. No.: 18/503,845

(22) Filed: Nov. 7, 2023

(51) Int. Cl. G06Q 20/10; G06Q 20/36; G06Q 20/38; G06Q 20/40

(52) U.S. Cl. CPC G06Q 20/10; G06Q 20/3678; G06Q 20/3829; G06Q 20/401; G06Q 2220/00

(57) ABSTRACT

Cloud computing services are provided based on a holding of cryptocurrency. An account can be created at a system of a cloud service provider for a compute user. A specification for at least one aspect of cloud computing services to be provided can be received. Access to cloud computing services is provided based at least in part on a determination of an amount of cryptocurrency held by the compute user. The cloud computing services can include artificial intelligence cloud computing services.

### TECHNICAL FIELD

This document relates to providing cloud computing services based on a holding of cryptocurrency.

### BACKGROUND

To truly cultivate the potential of artificial intelligence (AI), the contribution and application of AI should be the right of every individual. Restricting access will only hamper its development and make it more inaccessible to those persons or entities that stand to benefit the most from it. Such persons or entities include, but are not limited to, low-income families and developing nations. Gatekeeping AI behind black boxes run by entities whose sole objective is financial or political gain also poses a significant threat to the safety and integrity of our society. While AI has tremendous potential to benefit, it can be equally as destructive. This view is shared by many of the industry's leaders who have publicly stressed the importance of open-source democratization. AI has also been subject to the significant disadvantage that the ability to perform AI development has been severely limited due to the difficulty of obtaining funding, which at least partly stems from how AI development is performed using existing technology.

Cryptocurrencies are digital forms of currency that do not rely on a central authority for upholding or maintenance. Cryptocurrencies are enabled by a decentralized system making use of a distributed ledger to track replicated, shared, and synchronized data regarding transactions in the cryptocurrency. Some cryptocurrencies have been subject to significant disadvantages that at least partly stem from the ways in which cryptocurrency transactions are executed using the tools of technology. Such disadvantages include, but are not limited to, high volatility, because such previous cryptocurrencies have no measurable fair market value, and because their perceived value has largely been based on the faith of those who invest in them, and on the expectations of other investors; overvaluation, because speculators have been incentivized to overvalue cryptocurrencies, and no efficient mechanism has existed to drive the cryptocurrency away from its overvalued state; and inflation, which previously had been a substantial concern for investors.

### SUMMARY

In a first aspect, a method comprises: receiving an account creation request including compute user information for a compute user, the account creation request received by a system of a cloud service provider; creating, by the system of the cloud service provider, a first account for the compute user to receive access to cloud computing services to be provided by the cloud service provider, the first account created based at least in part on the compute user information; receiving, at the system of the cloud service provider, a specification for the first account of the compute user, the specification specifying at least one aspect of the cloud computing services to be provided by the cloud service provider; determining, by the system of the cloud service provider, a first amount of a cryptocurrency to be held by the compute user for receiving access to the cloud computing services, wherein the first amount of the cryptocurrency is determined after creating the first account and after receiving the specification, and wherein the first amount of the cryptocurrency is determined based at least in part on the specification; making a determination, by the system of the cloud service provider, regarding a second amount of the cryptocurrency actually held by the compute user; and providing access to the cloud computing services for the compute user, wherein the access is provided based at least in part on making the determination regarding the second amount of the cryptocurrency.

Implementations can include any or all of the following features. The method further comprises notifying the compute user, by the system of the cloud service provider and before making the determination regarding the second amount of the cryptocurrency actually held by the compute user, about the determination of the first amount of the cryptocurrency. Notifying the compute user about the determination of the first amount of the cryptocurrency comprises informing the compute user about i) an amount of fiat currency or ii) an amount of a different cryptocurrency, to be conveyed by the compute user for receiving access to the cloud computing services, the method further comprising: receiving, by the system of the cloud service provider, a payment from the compute user, the payment including the amount of the fiat currency or the amount of the different cryptocurrency; obtaining, by the system of the cloud service provider and based on receiving the payment from the compute user, the first amount of the cryptocurrency; and transferring, by the system of the cloud service provider, the first amount of the cryptocurrency to the compute user in response to receiving the payment from the compute user. In ii), the amount of the different cryptocurrency to be conveyed by the compute user for receiving access to the cloud computing services is a) to be paid by the compute user; b) to be invested by the compute user; c) to be transferred by the compute user; or d) to be otherwise transacted by the compute user. The system of the cloud service provider receives the payment before providing the access to the cloud computing services for the compute user. The system of the cloud service provider receives the payment after providing the access to the cloud computing services for the compute user. The system of the cloud service provider provides the access to the cloud computing services immediately after receiving the specification. The compute user obtains the second amount of the cryptocurrency at a cryptocurrency exchange. The system of the cloud service provider provides the access to the cloud computing services in response to the compute user having obtained the second amount of the cryptocurrency. The compute user is a first compute user, and wherein the first compute user obtains the second amount of the cryptocurrency from a second compute user. The first compute user obtains the second amount of the cryptocurrency at any time relative to the system of the cloud service provider providing the access to the cloud computing services. The compute user is entitled to an amount of the cloud computing services that is equivalent to the second amount of the cryptocurrency. The system of the cloud service provider reduces the cloud computing services compared to the specification in response to the second amount of the cryptocurrency being less than the first amount of the cryptocurrency. The method further comprises: determining, by the system of the cloud service provider and before making the determination regarding the second amount of the cryptocurrency, a third amount of the cryptocurrency actually held by the compute user, wherein the third amount of the cryptocurrency is less than the first amount of the cryptocurrency; in response to determining the third amount of the cryptocurrency, denying the access to the cloud computing services for the compute user; subsequently determining, by the system of the cloud service provider and after denying the access to the cloud computing services for the compute user, that the compute user actually holds a third amount of the cryptocurrency, wherein the access to the cloud computing services for the compute user is provided in response to subsequently determining that the compute user actually holds the third amount of the cryptocurrency. The compute user is a first compute user, wherein the specification is a first specification, wherein a second compute user has a second account with the cloud service provider, and wherein the second compute user obtains the second amount of the cryptocurrency from the first compute user after the cloud service provider begins providing access to the cloud computing services for the first compute user, the method further comprising: receiving, at the system of the cloud service provider, a second specification for the second account of the second compute user, the second specification specifying at least one aspect of the cloud computing services to be provided by the cloud service provider; determining, by the system of the cloud service provider, a third amount of the cryptocurrency to be held by the second compute user for receiving access to the cloud computing services, wherein the third amount of the cryptocurrency is determined after creating the first account and after receiving the second specification, and wherein the third amount of the cryptocurrency is determined based at least in part on the second specification; making a determination, by the system of the cloud service provider, regarding a fourth amount of the cryptocurrency actually held by the second compute user; and providing access to the cloud computing services for the second compute user, wherein the access is provided based at least in part on determining the fourth amount of the cryptocurrency. At least the compute user information is used in making the determination regarding the second amount of the cryptocurrency. The compute user information includes at least one of a cryptocurrency wallet address for a cryptocurrency wallet of the compute user, a public key for the compute user, or a private key for the compute user. At least a distributed ledger is used in making the determination regarding the second amount of the cryptocurrency. Using the distributed ledger includes viewing transactions in the distributed ledger that occurred between a time of the account creation request and a present time. Making the determination regarding the second amount of the cryptocurrency comprises determining a size of the second amount of the cryptocurrency. Making the determination regarding the second amount of the cryptocurrency comprises determining how long the compute user has actually held the second amount of the cryptocurrency. The system of the cloud service provider makes the determination regarding the second amount of the cryptocurrency by receiving notification of a performed verification. The cloud computing services include artificial intelligence cloud computing services.

In a second aspect, a non-transitory computer readable medium stores instructions that when executed by at least one processor cause operations to be performed, the operations comprising: receiving an account creation request including compute user information for a compute user, the account creation request received by a system of a cloud service provider; creating, by the system of the cloud service provider, a first account for the compute user to receive access to cloud computing services to be provided by the cloud service provider, the first account created based at least in part on the compute user information; receiving, at the system of the cloud service provider, a specification for the first account of the compute user, the specification specifying at least one aspect of the cloud computing services to be provided by the cloud service provider; determining, by the system of the cloud service provider, a first amount of a cryptocurrency to be held by the compute user for receiving access to the cloud computing services, wherein the first amount of the cryptocurrency is determined after creating the first account and after receiving the specification, and wherein the first amount of the cryptocurrency is determined based at least in part on the specification; making a determination, by the system of the cloud service provider, regarding a second amount of the cryptocurrency actually held by the compute user; and providing access to the cloud computing services for the compute user, wherein the access is provided based at least in part on making the determination regarding the second amount of the cryptocurrency.

In a third aspect, a non-transitory computer readable medium stores instructions that when executed by at least one processor cause operations to be performed, the operations comprising: submitting, to a system of a cloud service provider, an account creation request to create an account for a compute user to receive access to cloud computing services to be provided by the cloud service provider, the account creation request including compute user information for the compute user; submitting, to the system of the cloud service provider, a specification for the account of the compute user, the specification specifying at least one aspect of the cloud computing services; receiving, from the system of the cloud service provider, a notification about a first amount of a cryptocurrency to be held by the compute user for receiving access to the cloud computing services; wherein the compute user obtains a second amount of the cryptocurrency; and obtaining, by the compute user, access to the cloud computing services, wherein the access is obtained based at least in part on the compute user actually holding the second amount of the cryptocurrency.

Implementations can include any or all of the following features. The compute user obtains the access to the cloud computing services immediately after the system of the cloud service provider receives the specification. The compute user conveys i) an amount of fiat currency or ii) an amount of a different cryptocurrency to the system of the cloud service provider before obtaining the access to the cloud computing services. The compute user is a first compute user, and wherein the first compute user obtains the second amount of the cryptocurrency from a second compute user, or from a cryptocurrency exchange, before obtaining the access to the cloud computing services. The compute user is a first compute user, and wherein the first compute user obtains the second amount of the cryptocurrency from a second compute user, or from a cryptocurrency exchange, at any time relative to the system of the cloud service provider providing the access to the cloud computing services. The compute user is entitled to an amount of the cloud computing services that is equivalent to the second amount of the cryptocurrency actually held by the compute user. The cloud computing services include artificial intelligence cloud computing services.

### BRIEF DESCRIPTION OF DRAWINGS

FIG. 1 shows an example of a system that can provide cloud computing services based on a holding of cryptocurrency.

FIGS. 2-5 show examples of process flows relating to providing cloud computing services based on a holding of cryptocurrency.

Like reference symbols in the various drawings indicate like elements.

### DETAILED DESCRIPTION

This document describes examples of providing cloud computing services based on a holding of cryptocurrency. In some implementations, blockchain technology can be leveraged to provide less expensive (e.g., free) cloud computing. This can enable significantly wider segments of the population access to cloud computing services for performing development. In some implementations, AI cloud computing services are provided. For example, some or all of the drawbacks of AI mentioned above can be overcome. Also or instead, the issuance, management of, and investment in, cryptocurrency can be improved. For example, some or all of the drawbacks of certain cryptocurrencies mentioned above can be overcome.

Examples described herein refer to a cryptocurrency. As used herein, a cryptocurrency is a digital currency managed by a decentralized system using a distributed ledger. A distributed ledger is digital information that is replicated across multiple nodes in a peer-to-peer network. When a ledger update transaction is broadcast to the nodes, each of them independently processes an update transaction, and they collectively use a consensus algorithm to determine the correct copy of the updated ledger. A blockchain is an example of a distributed ledger. For example, the blockchain includes a growing list of records that can be securely linked together using cryptographic hashes (e.g., the outputs of a cryptographic hash function that maps arbitrary strings into strings of fixed size).

Examples described herein refer to obtaining a cryptocurrency. As used herein, obtaining a cryptocurrency includes any transaction by which someone becomes a holder of cryptocurrency. Obtaining a cryptocurrency includes, but is not limited to, purchasing the cryptocurrency, investing in the cryptocurrency, bartering for the cryptocurrency, receiving the cryptocurrency as a gift, receiving the cryptocurrency free of charge, inheriting the cryptocurrency, and combinations thereof.

Examples described herein refer to a cryptocurrency wallet. As used herein, a user creates or is given access to a cryptocurrency wallet for managing his or her holdings of cryptocurrency. The cryptocurrency wallet can include software that enables the user to obtain holdings of the cryptocurrency; the cryptocurrency wallet enables the user to manage and review current holdings or past transactions; and the cryptocurrency wallet enables the user to execute transactions of the cryptocurrency to, and receive transactions from, a third party. The cryptocurrency wallet can include a public key for the user (e.g., so the user can receive transactions of the cryptocurrency from a third party) and a private key for the user (e.g., so the user can make transactions of the cryptocurrency to a third party). A cryptocurrency wallet can be stored online to allow a trusted third party to inspect the balance held by the owner of the cryptocurrency wallet.

Examples described herein refer to a cloud service provider. As used herein, a cloud service provider is an entity (e.g., a human, company or other organization) that provides computing as a service to one or more compute users. Examples of cloud service providers currently available include, but are not limited to, Amazon Web Services, Google Cloud, or Microsoft Azure. Examples described herein refer to a system of a cloud service provider. As used herein, the system of the cloud service provider may or may not actually be owned and/or operated by the cloud service provider. As used herein, the system of a cloud service provider means any system that is operated for, operated for the benefit of, operated on behalf of, or operated by an agent of, operated by a representative of, operated by an owner of, operated by a subsidiary of, operated by a sister organization of, or operated by a business partner of, the cloud service provider. That is, the cloud service provider in the present subject matter may own and/or operate a system; on the other hand, another entity may operate its own system and act as an intermediary to verify to the cloud service provider transactions made by the compute user. In doing so, the intermediary may simply pass along verification status to the cloud service provider. That is, in the present subject matter, the intermediary's system is a system of the cloud service provider.

Examples described herein refer to a compute supplier. As used herein, a compute supplier is an entity (e.g., a human, company or other organization) that has the capacity to provide computing. Examples of compute suppliers include, but are not limited to, data centers, crypto farms, cloud service providers, or any person with a computer.

Examples described herein refer to a compute user. As used herein, a compute user is a human or an entity (e.g., an organization) that has been provided, or may wish to gain, access to cloud computing services. The compute user may use one or more computer devices (e.g., a desktop or laptop computer) to gain access to the one or more remotely located computer systems at which the cloud computing services are performed. At the request of a compute user, a cloud service provider can create an account for the compute user, with details entered by the user, to facilitate the provision of cloud computing services to the compute user. Namely, the user creates an account by entering their details (e.g., email address, password, etc.) using a user interface. The user submits the request to the cloud service provider's backend system to make a new account for the user.

Examples described herein refer to cloud computing services. In some implementations, providing access to the cloud computing services includes making a command-line interface available by which the compute user(s) can interact with cloud instances. In some implementations, providing access to the cloud computing services includes making an integrated development environment (IDE) available to the compute user. As used herein, AI cloud computing services includes any service that develops AI. The IDE can provide a graphical user interface (GUI) that is geared toward developing, editing, and running AI models. In some implementations, the IDE makes available the Jupyter Notebook, which is an interactive computing product made available under open-source licensing from the organization known as Project Jupyter, or any other IDE that facilitates training of AI models. The compute user can use the IDE of the AI cloud computing services to type code and run models, securely store data, create and execute automated workflows, deploy created AI such as a machine learning application, and/or create application programming interface endpoints that allow access to the developed AI. Any of several services or methods of delivery and use of the cloud computing services can be used.

Examples described herein refer to a specification for cloud computing services. As used herein, a specification includes a specification of at least one aspect of the cloud computing services to be provided to the compute user. Examples of such aspects include, but are not limited to, type of computer, type of processor, type of graphics processing unit, type of central processing unit, length of time, or combinations thereof.

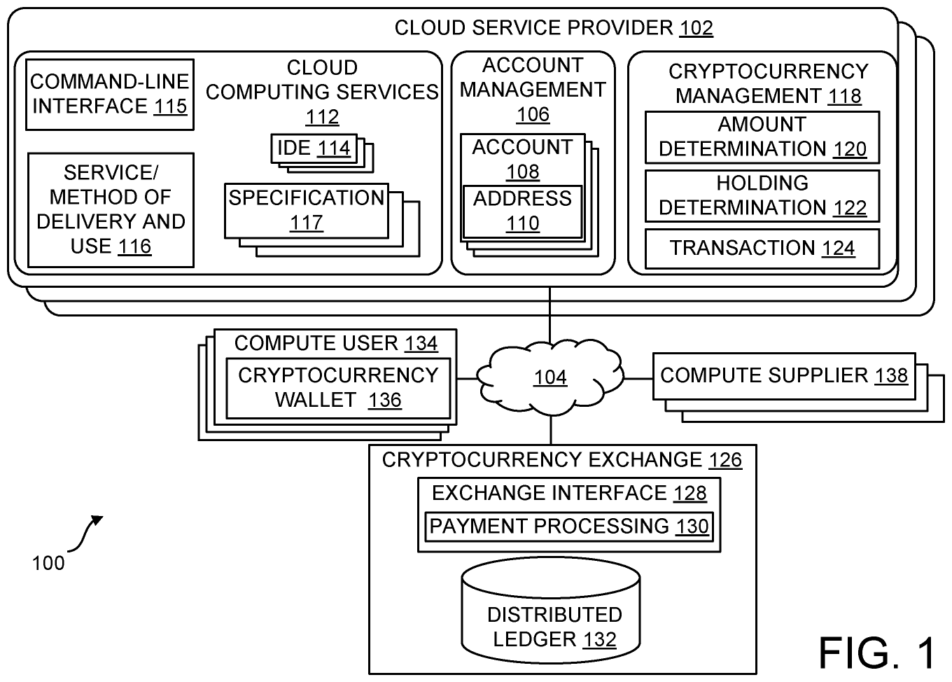

FIG. 1 shows an example of a system 100 that can provide cloud computing services based on a holding of cryptocurrency. The system 100 can be used with one or more other examples described elsewhere herein. The system 100 includes systems 102 that are each operated by a respective cloud service provider. Each of the systems 102 can connect with any or all other ones of the systems 102, and/or with other systems or devices, using a network 104. The network 104 can include one or more wired and/or wireless networks for computer communication. For example, the network 104 can include the internet. One or more components of the system 100 can be implemented using at least one processor that executes instructions stored in a computer readable medium. Such components can include, but are not limited to, servers or any other computer devices.

At least one of the systems 102 can be designated for providing cloud computing services based on a holding of cryptocurrency. Here, at least one of the systems 102 includes an account management component 106 configured for creating and managing one or more accounts 108 for a compute user. Having the account 108 can allow the compute user to obtain cloud computing services, for example as will be described below. The account 108 can be created based on compute user information about or otherwise relating to the compute user. For example, the compute user information can include a cryptocurrency wallet address 110 for the compute user (e.g., the cryptocurrency wallet address 110 is one of a virtually unlimited number of possible addresses that can be created from a user's public key).

At least one of the systems 102 includes a cloud computing services component 112 that can be used for providing access to cloud computing services for one or more compute users associated with the account(s) 108. The cloud computing services component 112 can make available one or more IDEs 114. In some implementations, AI cloud computing services are provided. For example, the IDE 114 allows a compute user to develop, edit, and run AI models using cloud computing services. The cloud computing services component 112 can make available a command-line interface 115 by which the compute user(s) can interact with cloud instances. Generally, the cloud computing services can be provided using any of several services or methods of delivery and use, as schematically illustrated by a service/method of delivery of use component 116. For example, the service/method of delivery of use component 116 represents any or all of a variety of microservices that can be provided with cloud computing services. The compute user can define one or more specifications 117 for the cloud computing services. The specification 117 defines at least one aspect of the cloud computing services to be provided by the cloud service provider. For example, the specification 117 regulates the type of processor (e.g., a graphics processing unit) and/or the duration of the cloud computing services for the compute user. As another example, while instances are only one example of a microservice that a cloud service provider can provide, the specification 117 can define one or more instances. For example, one or more storage microservices can be used in tandem with one or more computers in the cloud that is specified by an instance specification. As another example, one or more storage microservices can be used whether or not the user is also using any instances or other services of the cloud service provider.

At least one of the systems 102 includes a cryptocurrency management component 118 that can be used to manage investments in, manage purchases and sales of, and/or to monitor holdings of, cryptocurrency. The cryptocurrency management component 118 can include an amount determination function 120 that can be used for determining one or more amounts of cryptocurrency. The amount determination function 120 can determine an amount of a cryptocurrency that a compute user should hold for receiving access to the cloud computing services. The cryptocurrency management component 118 can include a holding determination function 122 that can be used for making a determination regarding one or more amounts of cryptocurrency. In some implementations, the holding determination function 122 can determine a size of an amount of a cryptocurrency that a compute user actually holds. In some implementations, the amount actually held can be determined using the cryptocurrency wallet address 110. As a first example, the wallet balance can be determined based on the compute user also providing their private key, and the system 102 can use the compute user's public and private keys to access the compute user's cryptocurrency wallet and view the funds. As a second example, the wallet balance can be determined based on the system 102 looking through all transactions in a distributed ledger that occurred within a time period and that are associated with the compute user's public key, or that are associated with the address of the compute user's cryptocurrency wallet, and by the system 102 performing accounting operations to determine or infer how much cryptocurrency the compute user is holding. For example, all transactions in the distributed ledger that occurred between a time of the account creation request and a present time can be viewed. In some implementations, the holding determination function 122 can determine how long the compute user has actually held the amount of the cryptocurrency (e.g., because holding the cryptocurrency for at least a threshold amount of time may qualify the compute user to obtain access to cloud computing services). The cryptocurrency management component 118 can include a transaction function 124 that can be used for conducting one or more types of transactions. For example, the transaction function 124 can receive fiat money, or a cryptocurrency, from a compute user or a third party. As another example, the transaction function 124 can obtain cryptocurrency from a third party. As another example, the transaction function 124 can electronically transfer cryptocurrency to a compute user or a third party.

The system 100 includes one or more systems 126 of a cryptocurrency exchange. The cryptocurrency exchange uses the system 126 to facilitate transactions in one or more types of cryptocurrency. The system 126 can include an exchange interface 128 that the cryptocurrency exchange makes available (e.g., to members of the public, or to select individuals and/or organizations) for purposes of performing transactions in, and/or otherwise managing holdings in, one or more cryptocurrencies. For example, the exchange interface 128 can provide a GUI that can be interacted with through the network 104. In some implementations, the exchange interface 128 provides payment processing 130. For example, the payment processing 130 can execute and/or document, one or more types of transactions in the cryptocurrency. The system 126 can include, or can have access to, a distributed ledger 132. The distributed ledger 132 can record transactions that involve the cryptocurrency and as such form part of a decentralized system for maintaining and documenting the cryptocurrency. For example, the distributed ledger 132 can include a blockchain. While only the system 126 is here shown as having the distributed ledger 132, it is understood that multiple nodes of the network 104 contain respective instances of the distributed ledger 132, so that consensus can be reached among them as to the validated transactions in the cryptocurrency.

The system 100 includes one or more systems 134 that are used by compute users to access cloud computing services, to manage and/or transact cryptocurrency, and optionally for other purposes. The system 134 can include, or otherwise provide the compute user access to, a cryptocurrency wallet 136. The cryptocurrency wallet 136 can include software and/or one or more keys associated with the compute user (e.g., a public key and a private key) that allow the compute user to view cryptocurrency holdings and execute transactions in cryptocurrency. The cryptocurrency wallet 136 is associated with the address 110 that is recorded by the account management component 106 of the system 102. In some implementations, when the compute user submits an account creation request to the account management component 106, the compute user can communicate the address 110 to the system 102 (e.g., by providing the compute user's wallet address or public key) so that the system 102 (e.g., by the holding determination function 122) can determine how much cryptocurrency the compute user is holding. The cryptocurrency wallet 136 can be stored locally at the system 134, or can be accessed remotely using the system 134, to name just two examples.

Any of the systems 134 can also or instead exchange cryptocurrency without using the system 126. Crypto users can exchange cryptocurrency between each other without using any intermediary. For example, one user can agree to send cryptocurrency from their address (e.g., the address of the cryptocurrency wallet 136 in this example) to another user. A third-party service can also or instead facilitate such exchanges. For example, the third-party service can help the user find and connect with another user who is willing to trade by providing a peer-to-peer platform. A compute user can obtain cryptocurrency from another user whether or not that other user has or ever had an account with the cloud service provider. A compute user can obtain cryptocurrency from another one of the compute user's accounts with the cloud service provider that is associated with a different cryptocurrency wallet.

The system 100 includes one or more compute suppliers operating respective systems 138. The systems 138 provide computing that facilitates the cloud computing services provided by the cloud service providers. The systems 138 operated by compute suppliers can include, but are not limited to, data centers, crypto farms, cloud service providers, computers (e.g., owned by individuals). The cloud computing services component 112 can provide the IDE 114, and/or the command-line interface 115, and/or any other service or method of the service/method of delivery of use component 116 to facilitate interaction with any of the systems 138 over the network 104.

The system 100 can solve one or more problems with the technology that has previously been used in the context of providing cloud computing services and/or managing cryptocurrencies. The system 100 can provide the technological improvement that opportunities for development (e.g., AI development) can be made available to increasing segments of people and entities, with new and more beneficial forms of funding that have previously not been available. The system 100 can introduce fair market value to a cryptocurrency, a benefit that has not previously been attainable. In so doing, the system 100 can combat high volatility in the value of the cryptocurrency, offering a solution that eliminates the influence of the faith of investors and others. For similar reasons, the system 100 can reduce or eliminate overvaluation and inflation in the cryptocurrency. The present subject matter can provide technology that makes it easier for compute users to gain access to cloud computing services. The present subject matter can provide technology that streamlines the computer-based operations involved in providing compute users access to cloud computing services. The present subject matter can provide many ways for a cloud services provider to keep track of a compute user's holdings of cryptocurrency and ensure that the compute user is provided with the correct amount of cloud computing services. Examples of this include, but are not limited to, scanning a distributed ledger for transactions involving the compute user's public key or wallet address during a specific timeframe; having a compute user connect their public key/wallet address and private key to the cloud services provider account, and giving the cloud services provider access to see their holding. One benefit of the present subject matter is ensuring that the cryptocurrency's value is tied to the usage (usage-value) of cloud services. Without the present subject matter, anyone could cheat the system and request resources without actually having transacted any cryptocurrency. If the system were cheated, the usage-value could not be guaranteed as mentioned above. In that sense, the present subject matter can prevent fraud.

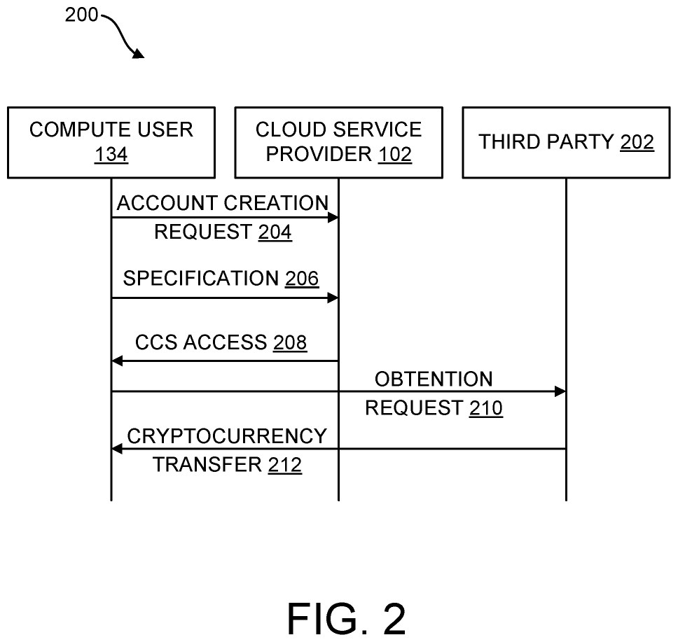

FIGS. 2-5 show examples of process flows 200-500, respectively. Each of the process flows 200-500 relates to providing cloud computing services based on a holding of cryptocurrency. Each of the process flows 200-500 involves at least the system 134 of a compute user, at least one of the systems 102 of the cloud service provider(s), and at least one third party system 202. The third party system 202 can be, or include, the system 126 of the cryptocurrency exchange, and/or another one of the systems 134 of compute users. When cloud computing services are provided by the cloud service provider in any of the process flows 200-500, this can also involve one or more of the systems 138 of the compute supplier(s), which are here not explicitly shown for simplicity. Some other components of the system 100 in FIG. 1 are mentioned in the following for illustrative purposes only. More or fewer operations than shown in the process flows 200-500 can be performed. Two or more operations can be performed in a different order unless otherwise indicated. One or more of the process flows 200-500 can be used with one or more other examples described elsewhere herein. In some implementations, one or more of the process flows 200-500 involves providing AI cloud computing services.

In the process flow 200, the system 134 performs an operation 204 of submitting an account creation request for receipt by the system 102 of the cloud service provider. For example, the operation 204 can be facilitated by a GUI that is made accessible to the compute user. The account creation request includes compute user information about the compute user so that an account can be created. The account creation request can include a cryptocurrency wallet address for a cryptocurrency wallet of the compute user. For example, the compute user can specify the address 110 of the cryptocurrency wallet 136. Also or instead, the compute user can provide the compute user's public key for verification with the cryptocurrency management component 118. If the holding determination function 122 is to be used for holding verification, the compute user can provide their private key to the system 102.

The system 134 performs an operation 206 of submitting a specification for receipt by the system 102. The specification specifies at least one aspect of the cloud computing services to be provided by the cloud service provider. For example, the specification 117 can be submitted to define one or more microservices, including but not limited to an instance, of the cloud computing services that the compute user seeks to obtain from the cloud service provider.

In some implementations, the compute user is granted access to the cloud computing services substantially immediately after the compute user orders the services. For example, the cloud service provider can grant the access in response to the compute user submitting the instance specification. Here, an operation 208 schematically represents the action(s) that the cloud service provider can take to provide cloud computing services to the compute user. In some implementations, such action(s) can involve multiple individual steps and/or can also or instead be directed at an additional entity.

The system 102 can determine how much (e.g., a “first amount”) of cryptocurrency the compute user, who now has an account with the cloud service provider, should hold in order to enjoy access to the cloud computing services. This determination can be made based at least in part on the instance specification. The system 102 can provide a notification to the compute user about the first amount either before or after the access is granted.

The compute user can obtain cryptocurrency before, during, and/or after the procedure of creating an account with the cloud service provider. Here, the system 134 performs an operation 210 of submitting a obtention request to the third party system 202. For the transaction, the compute user can convey fiat money (i.e., using non-cryptocurrency funds) or a cryptocurrency other than the one that the system 102 requires to be held for enjoying access to cloud computing services. For example, to convey the fiat money or the other cryptocurrency the compute user can a) pay, b) invest, c) transfer, or d) otherwise transact the flat money or the other cryptocurrency. The compute user receives a transfer of the cryptocurrency in an operation 212. For example, the operation 212 at least in part involves updating of a distributed ledger to reflect the transfer of the cryptocurrency to the compute user. In some implementations, the cryptocurrency so transferred can be held directly by the compute user, or can be held by the cloud service provider on behalf of the compute user, or can be held by any third party on behalf of the compute user. The obtained amount of cryptocurrency can be greater than, the same as, or less than the first amount that was determined by the system 102. In the cases where the amount actually obtained is greater or less than the first amount, the system 102 can choose an appropriate amount of resources to provide (i.e., more than, less than, or as much as requested). At some point in time, the system 102 can perform verification that the compute user holds at least the first amount of the cryptocurrency.

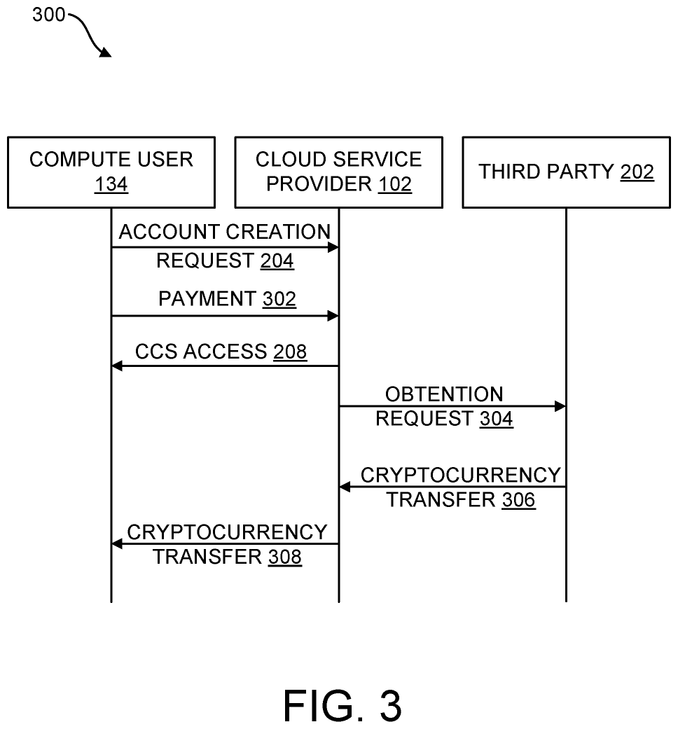

Turning now to the process flow 300 in FIG. 3, the system 134 can submit the account creation request in the operation 204. The system 102 can communicate the first amount of the cryptocurrency to the compute user either before or after the operation 204. In an operation 302, the system 134 can submit a payment for receipt by the system 102. The payment can be made using fiat money (i.e., using non-cryptocurrency funds) or using a cryptocurrency other than the one that the system 102 requires to be held for enjoying access to cloud computing services. The operation 208 schematically represents that the cloud service provider grants access to the cloud computing services.

The cloud service provider can obtain cryptocurrency either before or after the current compute user makes the payment in the operation 302. If the transaction is made after the operation 302, the cloud service provider can use the payment received from the compute user, or different funds, to complete the transaction in which cryptocurrency is obtained. Here, an operation 304 represents an obtention request from the cloud service provider to the third party (e.g., the transaction function 124 in FIG. 1 can be used to acquire cryptocurrency from the system 126 of the cryptocurrency exchange), and an operation 306 represents a cryptocurrency transfer from the third party to the cloud service provider. Here, an operation 308 represents a cryptocurrency transfer from the cloud service provider to the compute user.

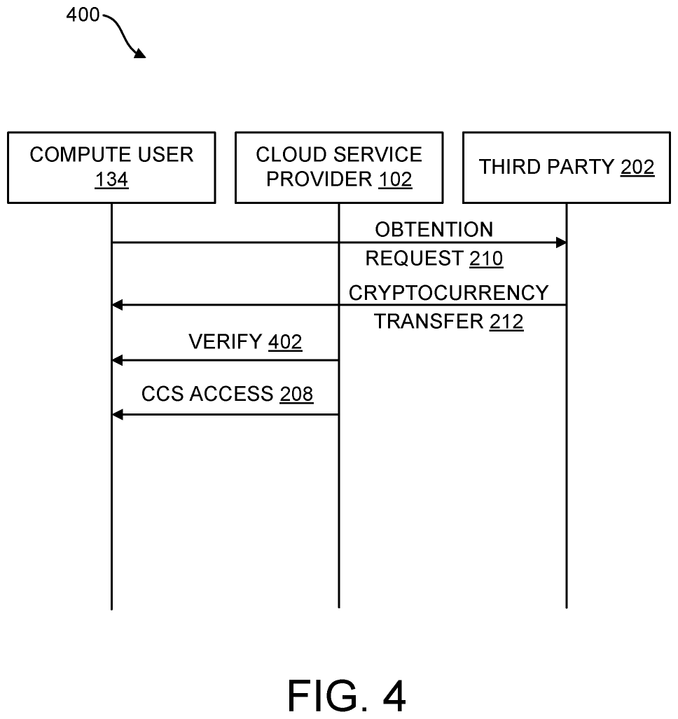

Turning now to the process flow 400 in FIG. 4, the system 134 can perform the operation 210 of submitting the obtention request to the third party system 202. The compute user receives a transfer of the cryptocurrency in the operation 212. As such, in the process flow 400 the compute user buys cryptocurrency in the market first and then obtains access to the cloud computing services.

The system 102 can determine the first amount of cryptocurrency the compute user, who has an account with the cloud service provider, should hold in order to enjoy access to the cloud computing services. The system 102 can communicate the amount to the compute user. The system 102 can perform an operation 402 of verifying that the compute user holds at least the required first amount of the cryptocurrency. For example, the system 102 can check the publicly available distributed ledger. In some implementations, the operation 402 of verifying that the compute user holds at least the required first amount of the cryptocurrency can be performed by an entity other than the cloud service provider that acts as an intermediary. For example, the intermediary can perform the operation 402 for, for the benefit of, or on behalf of, the cloud service provider. As another example, the intermediary can perform the operation 408 as an agent of, as a representative of, as an owner of, as a subsidiary of, as a sister organization of, or as a business partner of, the cloud service provider. That is, the system 102 can make the determination that the compute user holds at least the required first amount of the cryptocurrency by receiving notification of a performed verification. The operation 208 schematically represents that the cloud service provider grants access to the cloud computing services.

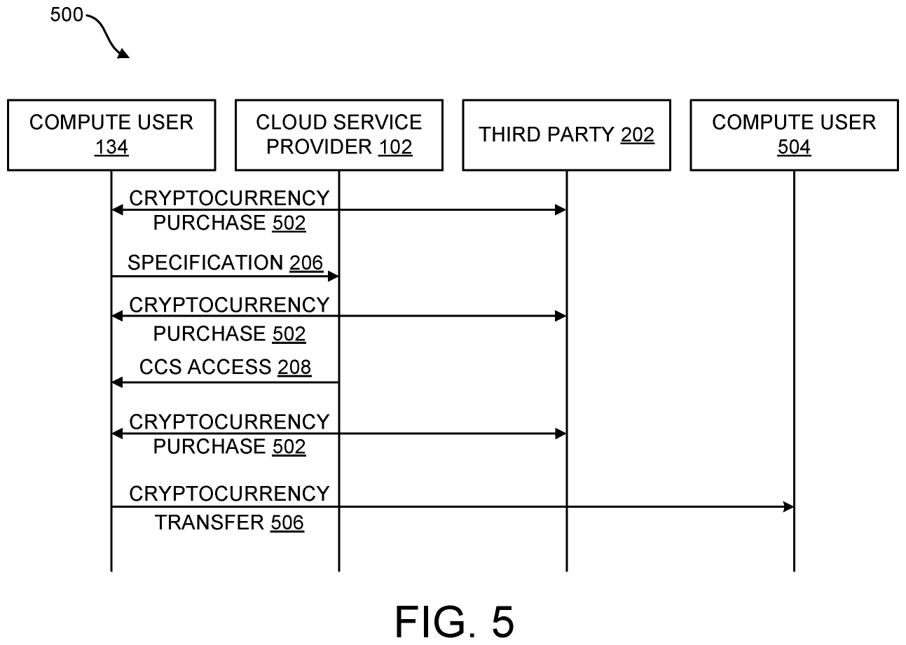

Turning now to the process flow 500 in FIG. 5, this example illustrates that the compute user can obtain cryptocurrency in the market at any time and is entitled to an equivalent amount of cloud computing resources. An operation 502 between the system 134 and the third party system 202 schematically illustrates that the compute user obtains cryptocurrency in the market from the third party. For example, the operation 502 can occur before the operation 206 where the compute user submits the instance specification. As another example, the operation 502 can occur after the instance specification before access is granted to the compute user in the operation 208. As another example, the operation 502 can occur after the access is granted to the compute user in the operation 208.

The process flow 500 also involves a system 504 of another compute user. That is, the system 504 is another one of the systems 134 in FIG. 1, operated by the other compute user. The compute user of the system 134 in the process flow 500 can perform an operation 506 of transferring some or all of the cryptocurrency to the other compute user of the system 504. This can be done after the cloud service provider begins providing access to the cloud computing services for the compute user. If the other compute user of the system 504 has an account with the cloud service provider, the other compute user can become entitled to receive access to resources for cloud computing services similar to the compute user of the system 134.

In some implementations, the compute user is entitled to an amount of cloud computing services corresponding to the amount of the cryptocurrency the compute user holds. The compute user can hold the cryptocurrency in their cryptocurrency wallet, or the compute user can use the cloud service provider to hold the compute user can use, or the compute user can use a third party as a proxy to hold the cryptocurrency. The amount held entitles the compute user to an equivalent amount of resources as long as the compute user is holding that amount of the cryptocurrency. The cloud service provider can confirm the amount held by the compute user by checking the cryptocurrency wallet using the address associated with the compute user's account, or by analyzing the transactions listed on a distributed ledger.

The compute user may be found to hold less than the amount of cryptocurrency required for the cloud computing services, as they are specified in the instance specification. As a first example, the cloud service provider can then deny the access to the cloud computing services until or unless the compute user is found to hold at least the required amount. That is, if the cloud service provider subsequently determines that the compute user holds at least the required amount, the cloud service provider can then grant access to the cloud computing services. As a second example, the cloud service provider can then reduce the cloud computing services, compared to the compute user's instance specification, based on the amount of cryptocurrency actually held by the compute user.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations or examples have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A method comprising:
receiving an account creation request including compute user information for a compute user, the account creation request received by a system of a cloud service provider;
creating, by the system of the cloud service provider, a first account for the compute user to receive access to cloud computing services to be provided by the cloud service provider, the first account created based at least in part on the compute user information;
receiving, at the system of the cloud service provider, a specification for the first account of the compute user, the specification specifying at least one aspect of the cloud computing services to be provided by the cloud service provider;
determining, by the system of the cloud service provider, a first amount of a cryptocurrency to be held by the compute user for receiving access to the cloud computing services, wherein the first amount of the cryptocurrency is determined after creating the first account and after receiving the specification, and wherein the first amount of the cryptocurrency is determined based at least in part on the specification;
making a determination, by the system of the cloud service provider, regarding a second amount of the cryptocurrency actually held by the compute user; and
providing access to the cloud computing services for the compute user, wherein the access is provided based at least in part on making the determination regarding the second amount of the cryptocurrency.

2. The method of claim 1, further comprising notifying the compute user, by the system of the cloud service provider and before making the determination regarding the second amount of the cryptocurrency actually held by the compute user, about the determination of the first amount of the cryptocurrency.

3. The method of claim 2, wherein notifying the compute user about the determination of the first amount of the cryptocurrency comprises informing the compute user about i) an amount of flat currency or ii) an amount of a different cryptocurrency, to be conveyed by the compute user for receiving access to the cloud computing services, the method further comprising:
receiving, by the system of the cloud service provider, a payment from the compute user, the payment including the amount of the flat currency or the amount of the different cryptocurrency;
obtaining, by the system of the cloud service provider and based on receiving the payment from the compute user, the first amount of the cryptocurrency; and
transferring, by the system of the cloud service provider, the first amount of the cryptocurrency to the compute user in response to receiving the payment from the compute user.

4. The method of claim 3, wherein in ii), the amount of the different cryptocurrency to be conveyed by the compute user for receiving access to the cloud computing services is a) to be paid by the compute user; b) to be invested by the compute user; c) to be transferred by the compute user; or d) to be otherwise transacted by the compute user.

5. The method of claim 3, wherein the system of the cloud service provider receives the payment before providing the access to the cloud computing services for the compute user.

6. The method of claim 3, wherein the system of the cloud service provider receives the payment after providing the access to the cloud computing services for the compute user.

7. The method of claim 1, wherein the system of the cloud service provider provides the access to the cloud computing services immediately after receiving the specification.

8. The method of claim 1, wherein the compute user obtains the second amount of the cryptocurrency at a cryptocurrency exchange.

9. The method of claim 7, wherein the system of the cloud service provider provides the access to the cloud computing services in response to the compute user having obtained the second amount of the cryptocurrency.

10. The method of claim 1, wherein the compute user is a first compute user, and wherein the first compute user obtains the second amount of the cryptocurrency from a second compute user.

11. The method of claim 10, wherein the first compute user obtains the second amount of the cryptocurrency at any time relative to the system of the cloud service provider providing the access to the cloud computing services.

12. The method of claim 1, wherein the compute user is entitled to an amount of the cloud computing services that is equivalent to the second amount of the cryptocurrency.

13. The method of claim 1, wherein the system of the cloud service provider reduces the cloud computing services compared to the specification in response to the second amount of the cryptocurrency being less than the first amount of the cryptocurrency.

14. The method of claim 1, further comprising:
determining, by the system of the cloud service provider and before making the determination regarding the second amount of the cryptocurrency, a third amount of the cryptocurrency actually held by the compute user, wherein the third amount of the cryptocurrency is less than the first amount of the cryptocurrency;
in response to determining the third amount of the cryptocurrency, denying the access to the cloud computing services for the compute user;
subsequently determining, by the system of the cloud service provider and after denying the access to the cloud computing services for the compute user, that the compute user actually holds a third amount of the cryptocurrency, wherein the access to the cloud computing services for the compute user is provided in response to subsequently determining that the compute user actually holds the third amount of the cryptocurrency.

15. The method of claim 1, wherein the compute user is a first compute user, wherein the specification is a first specification, wherein a second compute user has a second account with the cloud service provider, and wherein the second compute user obtains the second amount of the cryptocurrency from the first compute user after the cloud service provider begins providing access to the cloud computing services for the first compute user, the method further comprising:
receiving, at the system of the cloud service provider, a second specification for the second account of the second compute user, the second specification specifying at least one aspect of the cloud computing services to be provided by the cloud service provider;
determining, by the system of the cloud service provider, a third amount of the cryptocurrency to be held by the second compute user for receiving access to the cloud computing services, wherein the third amount of the cryptocurrency is determined after creating the first account and after receiving the second specification, and wherein the third amount of the cryptocurrency is determined based at least in part on the second specification;
making a determination, by the system of the cloud service provider, regarding a fourth amount of the cryptocurrency actually held by the second compute user; and
providing access to the cloud computing services for the second compute user, wherein the access is provided based at least in part on determining the fourth amount of the cryptocurrency.

16. The method of claim 1, wherein at least the compute user information is used in making the determination regarding the second amount of the cryptocurrency.

17. The method of claim 16, wherein the compute user information includes at least one of a cryptocurrency wallet address for a cryptocurrency wallet of the compute user, a public key for the compute user, or a private key for the compute user.

18. (canceled)

19. (canceled)

20. The method of claim 1, wherein making the determination regarding the second amount of the cryptocurrency comprises determining a size of the second amount of the cryptocurrency.

21. The method of claim 1, wherein making the determination regarding the second amount of the cryptocurrency comprises determining how long the compute user has actually held the second amount of the cryptocurrency.

22. The method of claim 1, wherein the system of the cloud service provider makes the determination regarding the second amount of the cryptocurrency by receiving notification of a performed verification.

23. The method of claim 1, wherein the cloud computing services include artificial intelligence cloud computing services.

24. A non-transitory computer readable medium storing instructions that when executed by at least one processor cause operations to be performed, the operations comprising:
receiving an account creation request including compute user information for a compute user, the account creation request received by a system of a cloud service provider;
creating, by the system of the cloud service provider, a first account for the compute user to receive access to cloud computing services to be provided by the cloud service provider, the first account created based at least in part on the compute user information;
receiving, at the system of the cloud service provider, a specification for the first account of the compute user, the specification specifying at least one aspect of the cloud computing services to be provided by the cloud service provider;
determining, by the system of the cloud service provider, a first amount of a cryptocurrency to be held by the compute user for receiving access to the cloud computing services, wherein the first amount of the cryptocurrency is determined after creating the first account and after receiving the specification, and wherein the first amount of the cryptocurrency is determined based at least in part on the specification;
making a determination, by the system of the cloud service provider, regarding a second amount of the cryptocurrency actually held by the compute user; and
providing access to the cloud computing services for the compute user, wherein the access is provided based at least in part on making the determination regarding the second amount of the cryptocurrency.

25. A non-transitory computer readable medium storing instructions that when executed by at least one processor cause operations to be performed, the operations comprising:
submitting, to a system of a cloud service provider, an account creation request to create an account for a compute user to receive access to cloud computing services to be provided by the cloud service provider, the account creation request including compute user information for the compute user;
submitting, to the system of the cloud service provider, a specification for the account of the compute user, the specification specifying at least one aspect of the cloud computing services;
receiving, from the system of the cloud service provider, a notification about a first amount of a cryptocurrency to be held by the compute user for receiving access to the cloud computing services;
wherein the compute user obtains a second amount of the cryptocurrency; and
obtaining, by the compute user, access to the cloud computing services, wherein the access is obtained based at least in part on the compute user actually holding the second amount of the cryptocurrency.

26. (canceled)

27. The non-transitory computer readable medium of claim 25, wherein the compute user conveys i) an amount of fiat currency or ii) an amount of a different cryptocurrency to the system of the cloud service provider before obtaining the access to the cloud computing services.

28. The non-transitory computer readable medium of claim 25, wherein the compute user is a first compute user, and wherein the first compute user obtains the second amount of the cryptocurrency from a second compute user, or from a cryptocurrency exchange, before obtaining the access to the cloud computing services.

29. The non-transitory computer readable medium of claim 25, wherein the compute user is a first compute user, and wherein the first compute user obtains the second amount of the cryptocurrency from a second compute user, or from a cryptocurrency exchange, at any time relative to the system of the cloud service provider providing the access to the cloud computing services.

30. (canceled)

31. (canceled)
